(19) United States
(12) Patent Application Publication
(10) Pub. No.: US 2024/0088805 A1
(43) Pub. Date: Mar. 14, 2024

(54) Method for braking a rotating tool of an electric machine tool and electric machine tool

(71) Applicant: Hilti Aktiengesellschaft, Schaan (LI)

(72) Inventors: Michael LACHER, Schwabmuenchen (DE); Manel OUNI, Augsburg (DE); Thomas MAHLER, Laage (DE)

(21) Appl. No.: 18/272,839

(22) PCT Filed: Nov. 15, 2021
(86) PCT No.: PCT/EP2021/081672

§ 371 Date: Jul. 18, 2023

(30) Foreign Application Priority Data
Feb. 8, 2021 (EP) 21155730.1

(51) Int. Cl. H02P 3/22; B24B 55/00

(52) U.S. Cl. CPC H02P 3/22; B24B 55/00

(57) ABSTRACT

A method for braking a rotating tool of an electric machine tool, wherein the electric machine tool includes a machine electronics system and a motor. A braking method in which the braking process includes sub-sequences for feeding back the released braking energy and for driving the electric motor. The braking method is characterized by a changeover between the sub-sequences, wherein the changeover takes place after predefined time periods for the individual sub-sequences have elapsed. An electric machine tool for carrying out the braking method is also provided. The electric machine tool may be, in particular, an electric grinder.

The present invention relates to a method for braking a rotating tool of an electric machine tool, wherein the electric machine tool comprises a machine electronics system and a motor.

### BACKGROUND OF THE INVENTION

For example, grinders with a grinding wheel as a rotating tool are known in the field of electric machine tools. After switching off a drive of such an electric machine tool, kinetic energy is stored in the rotational movement of the grinding wheel and, in principle, in the rotating components of the device. This kinetic energy depends on the mass and the rotation speed of the respective component and provides for an undesired further movement of the rotating components of the electric machine tool. A braking effect on these rotating components of the electric machine tool is brought about by the mechanical friction of the components in their areas of contact with the machine. This braking effect slows down the rotational movement of the rotating components of the electric machine tool and the components ultimately come to a standstill. If the rotation speed of such a rotating component of the electric machine tool is plotted against time, a so-called run-out curve results, which represents the slowing down of the rotating components of the electric machine tool.

Various methods are known in the prior art for braking a rotating component of an electric machine tool. For example, so-called short-circuit braking is practised on the motor, in which the phases of the electric motor of the electric machine tool are short-circuited. In this case, the electrical and magnetic resistance in the corresponding switching or active circuit acts similarly to the mechanical friction and leads to a braking of the grinding wheel. The disadvantage of so-called short-circuit braking, however, is that the braking process cannot be controlled. This means that neither the braking time nor the user experience can be influenced. Furthermore, a braking current is generated by short-circuiting the motor phases and this has to be handled or dissipated in some way.

### SUMMARY OF THE INVENTION

The supply of braking current to the motor is further known in the prior art. As a result, any braking current that occurs can be regulated. However, when braking current is supplied to the motor, energy flows into the intermediate circuit (bulk capacitance) of the electronics system of the electric machine tool (“machine electronics system”). The flow of energy can lead to an increase in the voltage in the intermediate circuit, wherein, if certain limit values are exceeded, this increase may be harmful to any electrolytic capacitors (“ELCOs”) that may be installed in the machine electronics system. However, such an undesired increase in voltage in the intermediate circuit of the machine electronics system can be avoided by providing braking choppers. However, this leads to an increased need for installation space within the electric machine tool and to increased manufacturing costs.

For example, US 2017 0234 484 A1 discloses a braking method for a brushless DC motor in a machine tool, in which different braking profiles are used as a function of braking states. DE 10 2012 110 271 A1 discloses a braking method for an electric motor in which a braking current is used as a control variable.

The object on which the present invention is based involves overcoming the deficiencies and disadvantages of the prior art described above and specifying braking methods for electric machine tools with which the rotating components of the machine, in particular its tool, can be braked quickly. In so doing, the improved braking methods should be controllable—preferably using as few and easily adjustable parameters as possible. Those skilled in the art would welcome it if an overvoltage in the intermediate circuit of the machine electronics system could be safely and effectively avoided without the corresponding machines having a higher volume and therefore becoming unwieldy. Furthermore, the provision of additional components should be avoided—for reasons of cost and space. The invention is also intended to provide an electric machine tool with which the braking method can be carried out.

According to the invention, a method for braking a rotating tool of an electric machine tool is provided, wherein the electric machine tool comprises a machine electronics system and a motor. This alternative braking method is characterized in that the braking process comprises a first sub-sequence and a second sub-sequence, wherein the first sub-sequence is assigned a first time period t_brake and the second sub-sequence is assigned a second time period t_drive, wherein a changeover is made between the sub-sequences after said time periods have elapsed, as a result of which switchover points between the sub-sequences are determined, wherein machine current values I_brake and I_drive are determined as a function of a voltage in an intermediate circuit of the machine electronics system.

For the purposes of the invention, it is preferred that, in the alternative braking method, a changeover between the sub-sequences of the braking process takes place according to a fixed time division. For the purposes of the invention, this preferably means that, for example, a fixed time period t_brake is defined for the first sub-sequence and a fixed time period t_drive is defined for the second sub-sequence. In other words, the sub-sequence “feeding back” can last, for example, for a time period t_brake, while the sub-sequence “driving” lasts for a time period t_drive.

For the purposes of the invention, it is preferred that the time period t_brake is greater than the time period t_drive. As a result, particularly rapid braking of the rotating tool of the electric machine tool can be achieved.

The method for braking a rotating tool of an electric machine tool can be described in another formulation by the following method steps:
a) starting a braking process for the rotating tool of the electric machine tool in a first sub-sequence of the braking process, wherein the first sub-sequence is assigned a first time period t_brake, wherein machine current values I_brake are determined as a function of a voltage in an intermediate circuit of the machine electronics system during the braking process,
b) changing over to a second sub-sequence after the first time period t_brake has elapsed,
c) continuing the braking process in the second sub-sequence for a second time period t_drive, wherein the machine current values I_drive are determined as a function of a voltage in an intermediate circuit of the machine electronics system during the second sub-sequence,
d) changing over to the first sub-sequence after the first time period t_drive has elapsed.

For the purposes of the invention, it is preferred that in this embodiment the voltage in the intermediate circuit of the machine electronics system does not exceed a component-permissible limit value which, if exceeded, may be harmful to individual components. In order to achieve this, it is preferred that the machine current values I_brake and I_drive in the corresponding sub-sequences are regulated in accordance with the intermediate circuit voltage. In other words, it is preferred for the purposes of the invention that the machine current values I_brake and I_drive are regulated as a function of the voltage in the intermediate circuit of the machine electronics system during the braking process.

The user of the electric machine tool does not or hardly notices the changeover between the sub-sequences. This is due, in particular, to the comparatively short time periods t_brake and t_drive. Owing to the comparatively short time periods in which the electric machine tool remains in the individual sub-sequences, the changeovers are not or hardly noticed by the user, this leading to a smooth perception of the braking process for the user of the electric machine tool.

The braking method has the advantage over the prior art that there are no additional material costs for additional components. In addition, a compact and easy-to-operate machine can be provided. Furthermore, an excessively high voltage in the intermediate circuit of the machine electronics system is reliably and effectively prevented and a particularly smooth braking process can be provided using the invention. By way of limiting the maximum currents flowing, a particularly smooth transition to the rotating tool of the electric machine tool being at a standstill is advantageously also rendered possible.

For the purposes of the invention, it is preferred that the rotating tool of the electric machine tool is braked by regulating and/or limiting the machine current values I_brake and I_drive. By way of limiting the maximum currents flowing, a particularly smooth transition to the rotating tool of the electric machine tool being at a standstill is advantageously rendered possible.

For the purposes of the invention, it is preferred that braking energy released in the first sub-sequence of the braking process is fed back into the intermediate circuit or that only low-side switches of the motor inverter of the electric machine tool are activated in the first sub-sequence of the braking process. Furthermore, a load cycle can be determined in the first sub-sequence of the braking process as a function of a speed of the rotating tool of the electric machine tool and/or as a function of a braking current of the motor of the electric machine tool. In the alternative embodiment of the invention, it is also preferred that in the second sub-sequence of the braking process of the motor of the electric machine tool is driven or that substantially all switches of the motor inverter of the electric machine tool are activated in the second sub-sequence of the braking process.

The braking method differs from the prior art, for example, in that sub-sequences, such as “feeding back” and “driving”, alternate as a function of a voltage, whereas in conventional braking methods a changeover can usually be made between different braking sequences. Furthermore, the current intensity is used as a control variable in many other braking methods, while in the present method a switchover or changeover is made from one sub-sequence to the other sub-sequence after prespecified time periods have elapsed.

There is moreover disclosed a further method for braking a rotating tool of an electric machine tool, wherein the electric machine tool comprises a machine electronics system and a motor. The method is characterized in that the braking process comprises a first sub-sequence and a second sub-sequence, wherein a changeover is made between the sub-sequences during the braking process and wherein switchover points between the sub-sequences are selected as a function of a voltage in an intermediate circuit of the machine electronics system. The terms, definitions and technical advantages introduced for the braking method presented first apply analogously to the further braking method, and vice versa.

For the purposes of the invention, it is preferred that the first sub-sequence is referred to as “feeding back”. Accordingly, in the first sub-sequence of the braking process, it is preferred that released braking energy is fed back into the intermediate circuit of the machine electronics system, so that the energy is available or can be used for further operation of the electric machine tool.

For the purposes of the invention, it is preferred that the machine tool has a switch arrangement for controlling the power of the motor. The switch arrangement can preferably comprise a motor inverter. In the first sub-sequence of the braking process, it is preferred for the purposes of the invention that only the negative- or ground-side switches (low-side switches) of the motor inverter of the electric machine tool are actuated. The switching elements of the motor inverter preferably have an integrated diode in the reverse direction in order to allow a corresponding current flow. If, for example, a metal-oxide semiconductor field-effect transistor (MOS-FET) is used as the switching element, it can be activated to improve the current flow in the reverse direction. For the purposes of the invention, it is preferred that the motor inverter is designed as a B6 bridge or as a switching element for actuating the motor. For the purposes of the invention, it is particularly preferred that the actuation is pulse width modulation actuation (PWM). The switching element can further be designed as a bipolar transistor with an insulated gate electrode (IGBT).

This can take place, in particular, in accordance with a commutation table for the motor of the electric machine tool. For the purposes of the invention, the sole activation of the low-side switches of the motor inverter preferably means that, in particular, the negative- or ground-side switches of the switch arrangement are active in the sub-sequence “feeding back”. For better understanding, these are referred to, for the purposes of the invention, as low-side semiconductors or low-side switches. For the purposes of the invention, it is particularly preferred that only low-side switches of the motor inverter of the electric machine tool are functionally activated in the first sub-sequence of the braking process. For the purposes of the invention, this preferably means that the low-side switches of the motor inverter of the electric machine tool can be used and actuated. For the purposes of the invention, it is preferred that one low-side switch or several of the low-side switches is/are actuated, i.e. activated in a regulated manner, in the PWM mode.

A load cycle can preferably be determined in the first sub-sequence of the braking process as a function of a speed of the rotating tool of the electric machine tool and/or as a function of a braking current of the motor of the electric machine tool. The driving variable for the braking current is the electromotive force of the electric motor of the machine tool. The electromotive force of the electric motor preferably depends on the rotation speed of the motor. For the purposes of the invention, it is preferred to use flexible PWM control in order to obtain controlled braking or device behavior.

For the purposes of the invention, it is preferred that the second sub-sequence is referred to as “driving”. Accordingly, it is preferred for the purposes of the invention that the motor of the electric machine tool is driven in the second sub-sequence of the braking process. The energy from the intermediate circuit preferably flows back into the motor in the sub-sequence “driving”. For the purposes of the invention, it is particularly preferred that the motor is designed as a brushless motor.

All switching elements of the switch arrangement of the electric machine tool are preferably activated in the second sub-sequence of the braking process. For the purposes of the invention, this preferably means that the switching elements can be used and preferably actuated in the PWM mode. The switching elements of the switch arrangement of the electric machine tool can preferably be actuated in the second sub-sequence of the braking process. The switching elements may be, in particular, the high-side switches and the low-side switches of the switch arrangement. For the purposes of the invention, it is particularly preferred that the high-side switches and the low-side switches are components of the motor inverter of the electric machine tool. For example, all switching elements of the motor inverter of the electric machine tool can therefore be activated in the second sub-sequence of the braking process. For the purposes of the invention, this preferably means that both the low-side switches and the high-side switches of the motor inverter of the machine tool are activated in the sub-sequence “driving”. For the purposes of the invention, it is particularly preferred that the high-side semiconductors and the low-side semiconductors are switched in a complementary manner to one another in the sub-sequence “driving”. Furthermore, it is preferred for the purposes of the invention that a conversion operation to block commutation is carried out in the sub-sequence “driving”, while a conversion operation to sinusoidal commutation is likewise possible. For the purposes of the invention, it is preferred that a high-side switch of the motor inverter is a positive-side switch of the switch arrangement.

It is provided in the context of the invention that the switchover points between the sub-sequences are selected as a function of a voltage in an intermediate circuit of the machine electronics system. The intermediate circuit preferably comprises or is formed by a direct-current intermediate circuit (DC link). It is preferred for the purposes of the invention that the switchover points are defined by a maximum trigger voltage U_DC_max and a minimum trigger voltage U_DC_min.

The method for braking a rotating tool of an electric machine tool can be described in a different formulation by the following method steps:
a) starting a braking process for the rotating tool of the electric machine tool in a first sub-sequence of the braking process,
b) determining a voltage in an intermediate circuit of the machine electronics system,
c) changing over to a second sub-sequence if the voltage in the intermediate circuit of the machine electronics system is greater than a maximum trigger voltage U_DC_max,
d) continuing the braking process in the second sub-sequence,
e) changing over to the first sub-sequence if the voltage in the intermediate circuit of the machine electronics system is lower than a minimum trigger voltage U_DC_min.

The braking method preferably begins with the first sub-sequence, in which the released braking energy is preferably fed back into the intermediate circuit of the machine electronics system. The voltage in the intermediate circuit of the electronics system of the electric machine tool is determined during the feeding back process. A changeover from the first sub-sequence to the second sub-sequence, i.e. for driving, takes place in particular when the previously determined voltage in the intermediate circuit of the machine electronics system is greater than a maximum trigger voltage U_DC_max. This preferably represents the first switchover point between the first and the second sub-sequence of the braking method. The braking process is then continued in the second sub-sequence until the voltage in the intermediate circuit of the machine electronics system is lower than a minimum trigger voltage U_DC_min, which preferably represents the second switchover point between the second and the first sub-sequence of the braking method. If the voltage determined in the intermediate circuit of the machine electronics system is lower than the minimum trigger voltage U_DC_min, a changeover back from the second sub-sequence to the first sub-sequence takes place. This changeover between the sub-sequences as a function of the voltage in the intermediate circuit of the machine electronics system can be repeated until the rotating tool of the electric machine tool has come to a standstill.

Tests have shown that a harmful overvoltage in the intermediate circuit can be effectively avoided using the method. In the context of the braking method, the braking sequence is advantageously uncomplicated and can be adjusted and changed with just a few parameters. Furthermore, no additional material costs have to be incurred for additional components. As a result, the installation space within the electric machine tool can also be kept small and a compact, easy-to-use device can be provided.

There is additionally disclosed an electric machine tool for carrying out the further braking method. For the purposes of the invention, it is preferred that the electric machine tool is an electric grinder.

For the purposes of the invention, it is preferred that the electric machine tool comprises a machine electronics system with an intermediate circuit, wherein the machine electronics system is configured to detect a voltage in the intermediate circuit and to compare it with a trigger voltage, wherein the machine electronics system is furthermore configured to change over between a first sub-sequence and a second sub-sequence of a braking process of the electric machine tool as a function of the detected voltage.

In a further aspect, the invention relates to an electric machine tool for carrying out the braking method. The terms, definitions and technical advantages introduced for the braking methods preferably apply analogously to the electric machine tool. For the purposes of the invention, it is preferred that the electric machine tool is an electric grinder.

For the purposes of the invention, it is preferred that the electric machine tool comprises a machine electronics system with an intermediate circuit, wherein the machine electronics system is configured to detect current values as a function of a voltage in the intermediate circuit, wherein the machine electronics system is furthermore configured to change over between a first sub-sequence and a second sub-sequence of a braking process of the electric machine after prespecified time periods have elapsed.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

Identical and similar components are denoted by the same reference signs in the figures, in which:

FIG. 1 shows a schematic representation of a preferred refinement of the further braking method

FIG. 2 shows a schematic representation of a preferred refinement of the braking method

FIG. 3 shows a schematic representation of a possible time sequence of the braking method

FIG. 4 shows a schematic representation of an electric grinder utilizing the present braking method.

### DETAILED DESCRIPTION

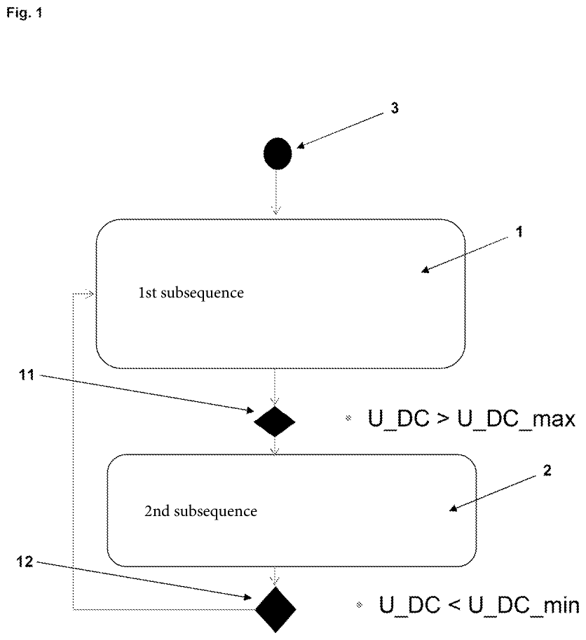

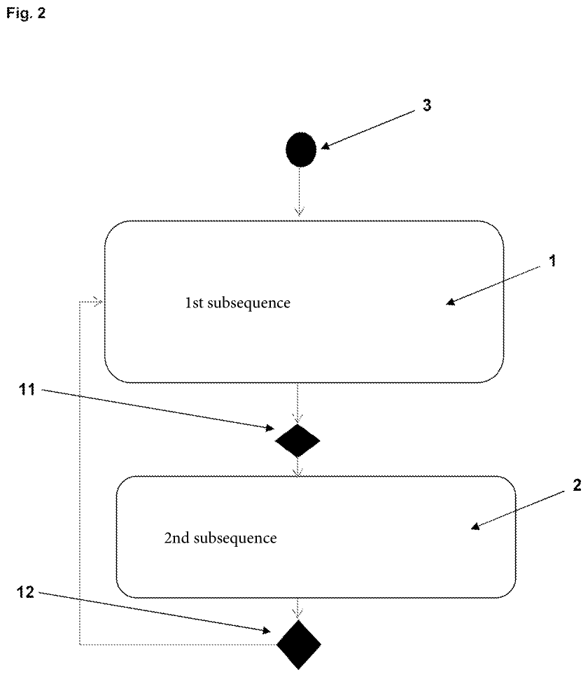

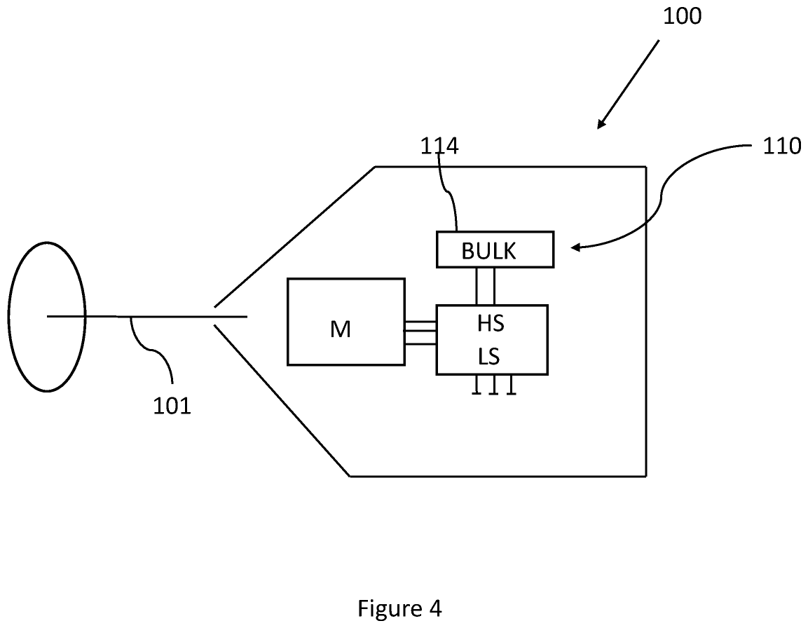

FIG. 1 shows a schematic representation of a preferred refinement of the further braking method. The further method for braking a rotating tool 101 (shown schematically in FIG. 4) of an electric machine tool (n-et shown schematically as 100 in FIG. 4) comprises a first sub-sequence 1 and a second sub-sequence 2, wherein the braking method preferably begins with a first sub-sequence 1. The start 3 of the braking process is represented by the round point at the top in FIGS. 1 and 2. The first sub-sequence 1 is preferably referred to as “feeding back”, while the second sub-sequence 2 is referred to as “driving”.

A changeover 11, 12 between the sub-sequences 1, 2 takes place as a function of a voltage U_DC in an intermediate circuit 114 (see, e.g., FIG. 4) of the machine electronics system 110 of the electric machine tool 100. In particular, a changeover 11 from the first sub-sequence 1 to the second sub-sequence 2 takes place when the condition U_DC>U_DC_max is met, while a changeover 12 from the second sub-sequence 2 to the first sub-sequence 1 takes place when the condition U_DC<U_DC_min is met. In other words, the switchover point 11 between the first sub-sequence 1 and the second sub-sequence 2 as well as the switchover point 12 between the second sub-sequence 2 and the first sub-sequence 1 can be defined or parameterized as a function of the intermediate circuit voltage U_DC of the electric machine tool. For the purposes of the invention, it is preferred that a first switchover point 11 between the first sub-sequence 1 and the second sub-sequence 2 is reached when U_DC>U_DC_max, while a second switchover point 12 between the second sub-sequence 2 and the first sub-sequence 1 is reached when U_DC<U_DC_min.

FIG. 2 shows a schematic representation of a preferred refinement of the braking method which is likewise disclosed in the context of the present invention. The method for braking a rotating tool of an electric machine tool comprises a first sub-sequence 1 and a second sub-sequence 2, wherein a changeover 11, 12 between the FIG. 1 shows a schematic representation of a preferred refinement of the braking method. The method for braking a rotating tool of an electric machine tool comprises a first sub-sequence 1 and a second sub-sequence 2, wherein a changeover 11, 12 between the sub-sequences 1, 2 takes place according to a specified time schedule. In particular, the sub-sequences 1, 2 are assigned fixed time periods t_brake and t_drive, a changeover 11, 12 taking place after said time periods have elapsed. In particular, a changeover 11 from the first sub-sequence 1 to the second sub-sequence 2 takes place after the first time period t_brake has elapsed, while a changeover 12 from the second sub-sequence 2 to the first sub-sequence 1 takes place after the second time period t_drive has elapsed.

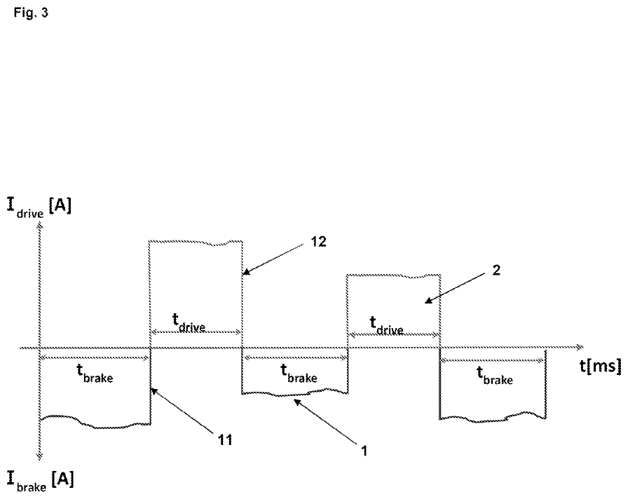

For the purposes of the invention, it is preferred that currents flow in the electric machine tool (“machine currents”) which are determined as a function of the intermediate circuit voltage U_DC of the machine electronics system. These machine currents are referred to as I_brake and, respectively, I_drive, wherein the current I_brake is assigned to the first sub-sequence 1 and flows during the first sub-sequence 1, while the current I_drive is assigned to the second sub-sequence 2 and flows during the second sub-sequence 2. A possible course of the machine currents I_brake and I_drive is shown in FIG. 3.

The changeovers 11, 12 between the sub-sequences 1, 2 can be repeated until the rotating tool of the electric machine tool has come to a standstill.

An exemplary sequence of the braking method is shown in FIG. 3.

### LIST OF REFERENCE SIGNS

1 First sub-sequence
2 Second sub-sequence
3 Start of the braking process
11 Changeover from the first to the second sub-sequence, first switchover point
12 Changeover from the second to the first sub-sequence, second switchover point
100 Electric grinder
101 Tool
110 Machine electronics system
114 Intermediate circuit
HS High side switches
LS Low side switches
M Motor

What is claimed is:

1-8. (canceled)

9. A method for braking a rotating tool of an electric machine tool, the electric machine tool having a machine electronics system and a motor, the method comprising:
performing a first sub-sequence and a second sub-sequence, the first sub-sequence being assigned a first time period t_brake and the second sub-sequence being assigned a second time period t_drive, a changeover being made between the first and second sub-sequences after the respective time periods have elapsed, switchover points between the first and second sub-sequences thereby being determined, wherein machine current values I_brake and I_drive are determined as a function of a voltage in an intermediate circuit of the machine electronics system.

10. The method as recited in claim 9 wherein a rotating tool of the electric machine tool is braked by regulating or limiting the machine current values I_brake and I_drive.

11. An electric machine tool for carrying out the braking method as recited in claim 9.

12. The electric machine tool as recited in claim 11 comprising the machine electronics system with the intermediate circuit, wherein the machine electronics system is configured to detect current values as a function of a voltage in the intermediate circuit, wherein the machine electronics system is furthermore configured to change over between the first sub-sequence and the second sub-sequence of the braking method of the electric machine tool after the respective first and second time periods have elapsed.

13. The electric machine tool as recited in claim 11 wherein the electric machine tool is an electric grinder.

14. The electric machine tool as recited in claim 11 further comprising a switch arrangement for controlling the power of the motor.

15. The electric machine tool as recited in claim 14 wherein the switch arrangement comprises a motor inverter.

16. A method for braking a rotating tool of an electric machine tool, the electric machine tool having a machine electronics system and a motor, the method comprising:
a) starting a braking process for the rotating tool of the electric machine tool in a first sub-sequence of the braking process, wherein the first sub-sequence is assigned a first time period t_brake, wherein machine current values I_brake are determined as a function of a voltage in an intermediate circuit of the machine electronics system during the braking process,
b) changing over to a second sub-sequence after the first time period t_brake has elapsed,
c) continuing the braking process in the second sub-sequence for a second time period t_drive, wherein the machine current values I_drive are determined as a function of a voltage in an intermediate circuit of the machine electronics system during the second sub-sequence, and
d) changing over to the first sub-sequence after the first time period t_drive has elapsed.

17. The method as recited in claim 16 wherein a rotating tool of the electric machine tool is braked by regulating or limiting the machine current values I_brake and I_drive.

18. An electric machine tool for carrying out the braking method as recited in claim 16.

19. The electric machine tool as recited in claim 18 comprising the machine electronics system with the intermediate circuit, wherein the machine electronics system is configured to detect current values as a function of a voltage in the intermediate circuit, wherein the machine electronics system is furthermore configured to change over between the first sub-sequence and the second sub-sequence of the braking method of the electric machine tool after the respective first and second time periods have elapsed.

20. The electric machine tool as recited in claim 18 wherein the electric machine tool is an electric grinder.

21. The electric machine tool as recited in claim 18 further comprising a switch arrangement for controlling the power of the motor.

22. The electric machine tool as recited in claim 21 wherein the switch arrangement comprises a motor inverter.
